(19) United States
(12) Patent Application Publication
(10) Pub. No.: US 2025/0055896 A1
(43) Pub. Date: Feb. 13, 2025

(54) CONTENT DELIVERY

(71) Applicant: BRITISH TELECOMMUNICATIONS PUBLIC LIMITED COMPANY, London Greater London (GB)

(72) Inventors: Michael NILSSON, London (GB); Stephen APPLEBY, London (GB); Rory TURNBULL, London (GB); Timothy STEVENS, London (GB)

(21) Appl. No.: 18/717,864

(22) PCT Filed: Nov. 23, 2022
(86) PCT No.: PCT/EP2022/082927

§ 371 Date: Jun. 7, 2024

(30) Foreign Application Priority Data
Dec. 10, 2021 (GB) 2117877.7

(51) Int. Cl. H04L 65/611; H04L 65/80

(52) U.S. Cl. CPC H04L 65/611; H04L 65/80

(57) ABSTRACT

A method of managing content delivery to a client device by a proxy, where the content is made up of a sequence of segments. The proxy starts off by receiving content requests from the client device over unicast, and fulfilling those requests by forwarding them to a content server, and receiving that content over unicast before forwarding onto the client device. The proxy then determines that a multicast channel should be joined to more efficiently receive the content. However, the multicast channel is likely to be ahead of the available unicast data. Therefore, a multicast join command is delayed until the proxy has taken steps to obtain subsequent content by unicast faster than that content is being requested by the client device, so that the obtained content has caught up with the content available on the multicast channel. The proxy can do so by requesting some of this content from the re-transmission server in advance of it being requested by the client device, and some from the content server in response to requests from the client device. Only when the requested content has caught up with the multicast channel does the proxy take action to join the multicast channel.

### FIELD OF THE INVENTION

This invention relates to the field of managing content delivery in a network, in particular managing content delivery using a combination of unicast and multicast.

### BACKGROUND TO THE INVENTION

Video content is currently commonly delivered to a range of client devices using unicast delivery, where a single stream of data is transmitted to each individual client device. Web (HTTP) technology is used for the content delivery, where the content is segmented into short segment files, typically around six to ten seconds in duration, enabling each segment file to be requested by and delivered to the client device using HTTP.

Each segment may also be encoded at a set of quality levels, each with a different bit rate and hence different file size. The client device monitors its buffer level and the network throughput achieved, and determines from these at which quality to request the next segment in order to achieve a good compromise between media quality and timely delivery. This is commonly referred to as adaptive bitrate (ABR) streaming.

However, HTTP is delivered over unicast (one to one) transport, so is inefficient for delivering the same content at the same time to many client devices. Multicast (one to many) transport would be far more efficient. Yet multicast is currently rarely used for any services other than network operators' on-net linear video channels delivered to their own set-top boxes. The main reason for this is that multicast does not lend itself to open use on the Internet.

To bring the benefits of multicast scalability to HTTP-based Internet media streaming, a class of techniques known as Multicast-Adaptive Bitrate (m-ABR) is being investigated and standardised.

Multicast-Adaptive Bitrate (m-ABR) is a relatively new technology. It aims to allow more efficient delivery of ABR content over networks by enabling the use of multicast for content streams where many clients are requesting the same content at about the same time.

One ambition of many m-ABR systems is to deploy multicast and enable m-ABR without any change to the client device and the client application that are already supporting HTTP (unicast) streaming. This can be achieved using a hybrid approach that uses a combination of both multicast and unicast delivery, where a proxy is inserted between the client device and the content server. The proxy can inspect content requests from the client device, and when appropriate, subscribe to a multicast stream, receive multicast content, and provide this content to the client, packaged to look like unicast delivered content.

Examples of such hybrid solutions include: “IP Multicast Adaptive Bit Rate Architecture Technical Report” OC-TR-IP-MULTI-ARCH-C01-161026, 26/10/2016, by Cable Labs; 3GPP specifications, 23.246 (MBMS Architecture and functional description), 26.346 (MBMS Protocols and codecs) and 26.347 (MBMS APIs); and DVB “Adaptive Media Streaming over IP Multicast” ETSI TS 103 769 V1.1.1 (2020-11).

Problems can occur when switching between unicast and multicast in current hybrid solutions.

One issue is that the multicast channel will typically have a lower latency than the unicast channel, so content segments received over the multicast channel may be ahead of the content segments received over unicast channel. In such cases there will be missing segments between that received at the proxy in response to the unicast requests from the client device and the content segments received by the proxy on the multicast channel. These missing segments must be obtained while continuing to receive the multicast channel. This simultaneous receiving of both multicast data and unicast data to fill the gap is problematic on connections that have low (insufficient) bandwidth. The multicast channel, which has no implementation of congestion control or any other way of reducing its transmission rate, will use the amount of bandwidth it needs regardless of the presence of any unicast transmissions.

Therefore on a low bandwidth connection, the transmission rate of the unicast data to fill the gaps between data previously received by unicast and the data received on the multicast channel will be at a reduced rate, and hence the resulting segments may not be received by the client device in time for continuous play-out of the content, and play-out may stall.

This slow or delayed delivery of content to the client device, which is behaving as a normal ABR streaming device, may cause it to change the quality level of the segments being requested, as the slow delivery of content segments would be seen as indicative of a slow network connection. This then in turn makes the data being received at the proxy over multicast unsuitable (it is at the wrong quality level) to satisfy the new requests made by the client device, which may cause the proxy to leave the multicast channel and return to satisfying the requests from the client device by obtaining the data by unicast.

Some solutions currently available prevent the client device from adapting to a different quality level by signalling that the content is only available at a single bit rate. However, this gives a poor user experience with interruptions to the presentation of content at the client device when the network throughput is insufficient for this single encoded quality level. Such interruptions may cause the presentation of content to stall and/or some content not being presented at all.

Other solutions just assume that there is much more bandwidth available for the delivery of content to the client device than that needed for a single encoded stream. Hence there would be no problem with the simultaneous delivery of content by unicast and multicast during the transition period, which in practice is not always the case.

### SUMMARY OF THE INVENTION

It is the aim of examples of the present invention to provide an improved content delivery mechanism that addresses one or more of the above problems.

According to one example of the invention, there is provided a method of managing content delivery over a network to a client device by a network element, said content comprising a sequence of segments, said method comprising:
receiving requests for segments from a client device, and transmitting the requested segments to the client device by unicast, wherein the transmitted segments are obtained by the network element by:
requesting one or more of the requested segments from a unicast content source;
deciding to join a multicast channel; then
requesting and receiving further segments from the unicast content source and an alternative unicast content source, and storing the further segments until requested by the client device; and
joining a multicast channel and receiving segments over multicast, and storing the segments until requested by the client device.

The further content segments from the unicast content source may be requested in response to corresponding requests received from the client device. The further content segments from the alternative unicast content source may be requested in advance of corresponding requests from the client device.

At any given time, there may be segment data available by multicast and from the alternative unicast source that isn't yet available from the unicast content source.

The alternative unicast content source may be a retransmission server.

According to a further example of the invention, there is provided a network element for managing content delivery to a client device, said content comprising a sequence of segments, said network element adapted in operation to:
receive requests for segments from a client device, and transmit the requested segments to the client device by unicast;
request one or more of the requested segments from a unicast content source;
decide to join a multicast channel;
request and receive further segments from the unicast content source and an alternative unicast content source, and storing the further segments until requested by the client device; and
join a multicast channel and receiving segments over multicast, and storing the segments until requested by the client device.

### BRIEF DESCRIPTION OF THE DRAWINGS

For a better understanding of the present invention reference will now be made by way of example only to the accompanying drawings, in which:

FIG. 1 system diagram showing the main components of an example of the present invention;

FIG. 2 is a flow chart summarising the steps of an example of the invention;

FIG. 3 is an example timing diagram showing segment transmission over time;

FIG. 4 is a graph showing an example of segment delivery over time;

FIG. 5 is another example timing diagram showing segment transmission over time; and

FIG. 6 is a graph showing another example of segment delivery over time.

### DESCRIPTION OF PREFERRED EMBODIMENTS

The present invention is described herein with reference to particular examples. The invention is not, however, limited to such examples.

Examples of the present invention provide a method of managing content delivery to a client device by a proxy, where the content is made up of a sequence of segments. The proxy starts off by receiving content requests from the client device over unicast, and fulfilling those requests by forwarding them to a content server, and receiving that content over unicast before forwarding onto the client device. At some stage, the proxy determines that a multicast channel should be joined to more efficiently receive the required content. However, the multicast channel is likely to be ahead of the available unicast data. Therefore, a multicast join command is delayed until the proxy has taken steps to obtain subsequent content by unicast faster than that content is being requested by the client device, so that the obtained content has caught up with the content available on the multicast channel. The proxy can do so by requesting some of this content from the retransmission server in advance of it being requested by the client device, and some from the content server in response to requests from the client device. Only when the requested content has caught up with the multicast channel does the proxy take action to join the multicast channel, such as by issuing an IGMP join request.

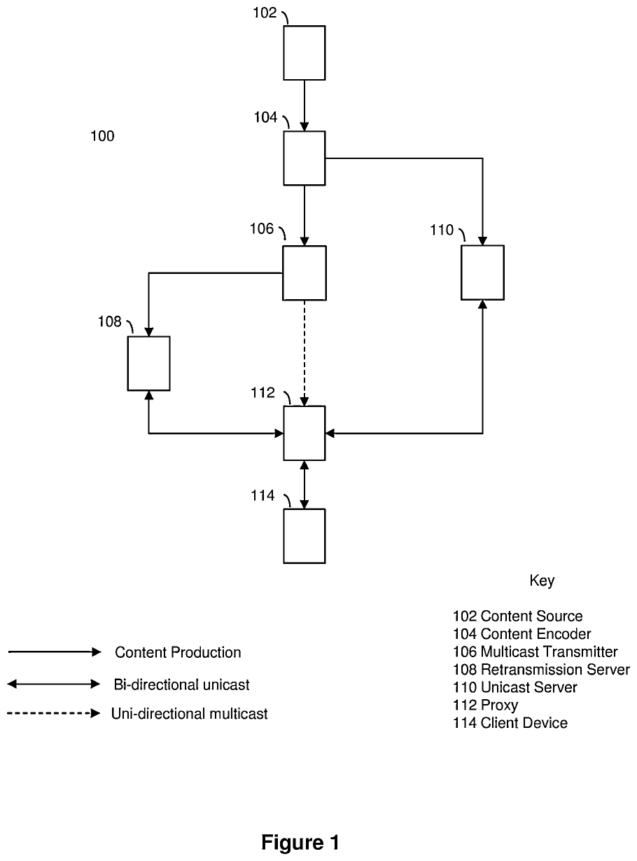

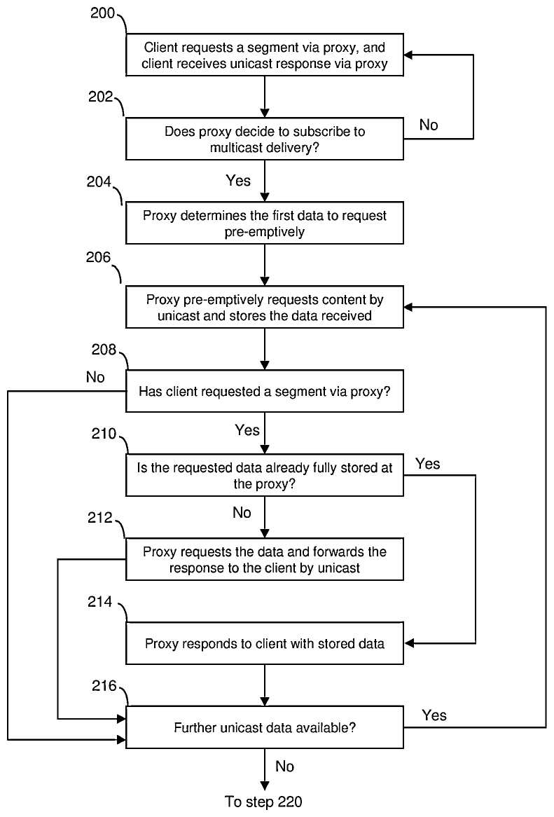

FIG. 1 shows an adaptive bit rate (ABR) streaming system 100 comprising the main components of an example of the invention. The system 100 comprises a content source 102, a content encoder 104, a multicast transmitter 106, a retransmission server 108, a unicast content server 110, a proxy 112 and a client device 114. The content source 102 provides content, such as a live sports or TV broadcast, in the form of video sequences to the content encoder 104.

The proxy 112 may be located within a device such as a home gateway or router.

The client device 114 is assumed to be running a client application, which is the source of content requests. For simplicity, the term client device has been used to refer to a client device running a client application.

The content encoder 104 receives the content from the content source 102 and encodes it using a suitable compression scheme, such as ITU-T Recommendation H.264 for video content, and segments the encoded content into a sequence of content segments, each content segment typically of duration 2 to 10 seconds. The content encoder 104 also encodes the content at one or more quality levels or bit rates, resulting in one or more (at each quality level) encoded segments corresponding to each uncompressed content segment. Such an arrangement is typical of an adaptive bit rate streaming service.

The content segments encoded at one quality level, corresponding to one encoded bit rate, are passed to the multicast transmitter 106 for transmission by multicast to any devices that have subscribed to the respective multicast source. However, the invention is not limited to this case, and also applies when content segments encoded at a plurality of quality settings, corresponding to a plurality of encoded bit rates, are passed to the multicast transmitter 106 for transmission by multicast on a plurality of multicast channels (one channel per quality setting).

The multicast transmitter 106 transmits the stream of encoded content segments on a suitably configured multicast channel to all devices that have subscribed to that multicast channel. The multicast transmitter 106 also sends the content segments to the retransmission server 108 where they are stored. Unlike unicast transmission, which usually makes use of a reliable transport protocol such as TCP or QUIC, multicast transmission usually makes use of an unreliable transport protocol such as UDP. Consequently, the system 100 includes the retransmission server 108, which enables receivers that are receiving content by multicast to request and receive content that was not successfully delivered by multicast over the unreliable transport protocol.

Content segments are made available on the retransmission server 108 as soon as they have been transmitted over multicast by the multicast transmitter 106. Receivers of the multicast data can request any missing content segments that were not successfully delivered by multicast from the retransmission server 108. Receivers can make unicast requests for missing content segments directed at the retransmission server 108, which responds over unicast with the missing segments using the stored data.

The content encoder 104 passes the encoded content segment data, encoded at all of the required bit rates, to the unicast server 110 where the data is stored and made available for delivery by unicast. The unicast server 110 responds to unicast requests for content segments with unicast responses using the stored data.

In these examples, the content segments are available to request from the retransmission server 108 before they are available to request from the unicast server 110. Considered another way, at any moment in time, the retransmission server 108 has more recent content segment data available than that at the unicast server 110.

The client device 114 can obtain a manifest file from the unicast server 110. Manifest files are used by client devices to identify where segments are located (by a URL in the manifest). The client device 114 can then request these segments in sequence using HTTP requests from the unicast server 110, and concatenate them to form a continuous stream of segments for playback. As each segment is available on the unicast server 110 at a plurality of encoded bit rates, the client device 110 determines for each content segment, the encoded bit rate (quality) at which to request it, taking into account such factors as the available network throughput and how much data is already received and buffered at the client device awaiting play-out.

Some HTTP requests made by the client device 114 for content will not make use of multicast delivery and are sent directly to the unicast server 110, which delivers the requested content by unicast. Other requests for content from the client device 114 that may benefit from multicast delivery are re-directed to, or simply intercepted by, the proxy 112, and can be handled in accordance with the examples described below.

The proxy 112 can be inserted in the HTTP path using any of a number of well-known techniques, such as using an HTTP redirection from the unicast server 110. In this case, the unicast server 110 would be configured such that requests for potentially popular content are not served directly but instead redirected to a suitable proxy. For example, instead of supplying a normal response, the unicast server 110 could respond with an HTTP status code 307 which indicates a temporary redirect. This invites the client device 114 to make a new request to the new URL supplied by the unicast server 110 in its response, thus enabling requests to be made to the proxy 112. This technique allows the unicast server 110 and the proxy 112 to exist in different domains, which would often be the case.

Other mechanisms to insert the proxy 112 in the HTTP path include: proxy configured as a transparent proxy (though all requests are intercepted by it, and only works with unencrypted traffic); proxy configured as a forward proxy (where the client device sends its requests directly to the proxy by virtue of being explicitly configured to do so); DNS hijacking (where a DNS server is configured to supply the IP address of the proxy for domains of interest); and manifest manipulation (where the manifest file is re-written so that requests are made directly to the proxy).

The client device 114 could request and receive segments from the unicast server 110 from the start to the end of a streaming session. However, in some cases the proxy 112 determines that multicast delivery could be used to receive some segments.

The proxy 112 monitors unicast content requests from the client device 114 and is aware of when content requested by the client device 114 could be received by multicast.

The proxy 112 determines when it is possible to satisfy the client device's requests for content using data that could be delivered by multicast, joins the relevant multicast channel at an appropriate time, and, after receiving data by multicast, replies to the client device's requests for unicast content with content received by multicast, but packaged as a unicast content response.

The client device 114 does not need to be aware of the proxy 112 and does not need to be aware of whether content is being delivered by unicast from the unicast content source via the proxy, or is delivered by multicast to the proxy which then delivers the content to the client device 114 in a unicast format.

There are many ways in which the proxy 112 may determine it is possible to satisfy the client device's requests for content using data that could be delivered by multicast.

For example, if client device 114 has made a plurality of consecutive requests for content segments at the same encoding quality level, that quality level is available by multicast delivery, and each of these content segments has been delivered in less time than the segment period.

In another example, the proxy 112 may ignore the fact that some segments have taken more time than a segment period to be delivered, provided that many segments are delivered in much less than a segment period. The proxy 112 may also ignore some variations in the quality at which segments are requested, if for much or all of the time there is easily sufficient network throughput to deliver content segments at the quality level available by multicast.

In some systems, when the proxy 112 has decided to satisfy the client device's requests for content using data that could be delivered by multicast, the proxy 112 stops forwarding the client device's requests for content to the unicast server 110, and instead can take appropriate action to join and obtain from the multicast channel, the data requested by the client device 114. The proxy 112 then delivers that content received over multicast to the client device 114, with the data formatted as a unicast response.

However, such an approach can result in the problems identified earlier (missing data, and resulting problems in particular with low bandwidth systems, etc). The Applicant's co-pending application GB2104529.9 describes solutions of how content can be delivered in an improved manner to address such problems.

In one solution, the proxy 112 determines that a multicast channel should be joined as described above. However, instead of issuing a command to join (such by an IGMP join request) the multicast channel immediately, the proxy 112 delays taking that action, and instead performs the following method.

The proxy 112 instead takes steps to obtain data by unicast faster than that data is being requested by the client device 114, until the obtained data has caught up with the data available on the multicast channel. In other words, the data that the proxy 112 is obtaining by unicast has only just been delivered on the multicast channel, and no further data is available by unicast. The proxy 112 stores this data and responds to client requests using this data.

To obtain data faster than requested by the client device 114, the proxy 112 predicts the next data that the client device 114 is likely to request. Although the proxy 112 could try to obtain all of this data from the unicast content server 110, this may not be possible for a variety of reasons. One such reason is that without the session-specific parameters of a request from the client device 114, the proxy 112 making requests alone may not meet the security requirements to be supplied with the content from the unicast content server 110 (as only the requests originating from the client device 114 will have the required parameters). Another reason is that there may be a delay between when data is available on the multicast and when it is available from the unicast server 110 for unicast delivery, for example, a segment may not be available to request from the unicast server 110 until it has been fully delivered by multicast.

Thus, in this solution, the proxy 112 makes requests for this in advance of requests from the client device 114 from the retransmission server 108, as the retransmission server 108 is provided with segment data as soon as it is available on the multicast channel. Furthermore, the segment data available at the retransmission server can be obtained without providing any session-specific security or authentication details (that only the client device 114 can typically provide). The proxy 112 can then take action to join the multicast channel, such as by issuing an IGMP join request.

Such a solution is set out in the Applicant's co-pending application GB2104529.9.

Note, in the above solution, the proxy 112 is obtaining data by unicast in advance of the requests for that data being received from the client device 114. Thus, whilst the proxy 112 is making requests for data in advance, the proxy 112 will still be receiving requests for data from the client device 114, which the proxy 112 can respond to using the data already received and stored.

However, the retransmission server 108 may have limited capability to service (i.e. receive and respond to) such requests from the proxy 112. In particular, the retransmission server 108, which is designed and deployed to serve only data that was lost during multicast transmission, may have much lower capacity then the unicast content server 110 that is used to deliver entire content assets by unicast to multiple client devices.

Described now are examples of how content can be delivered in an improved manner, by reducing the amount of such data that is requested from the retransmission server 108 by requesting some data from the unicast content server 110. Furthermore, the issues described above in relation to obtaining data from the unicast content server 110 without suitable security credentials would also be avoided by only requesting data from the unicast content server 110 when a corresponding request has been received from the client device 114, and forwarding that request onto the unicast content server 110.

In relation to obtaining the data required for the purpose of transitioning from receiving content by unicast to receiving content by multicast, the proxy 112 may determine which of these data to request pre-emptively from the retransmission server 108 and which of these data to obtain from the unicast content server 110 following corresponding requests from the client device 114 by considering these data as two sets of data: a first set of data being data that has already been delivered on the multicast channel and a second set of data being data that has not yet been fully delivered on the multicast channel.

In order to divide these data into the first set of data and the second set of data, the proxy determines which data has most recently been delivered on the multicast channel. It may do this, for example, by making a request to either the multicast transmitter 106 or the retransmission server 108 for this information. The response may indicate the specific part of the specific content segment that is currently being delivered by multicast, or may indicate the specific content segment that is currently being delivered by multicast and the time at which the transmission of that specific content segment started.

The proxy 112 makes requests for data in the second set of data from the retransmission server 108, after that data has been multicast. The proxy 112 obtains some or all of the data in the first set of data, that is, data that has already been delivered on the multicast channel, by waiting for requests from the client device 114, and forwarding these requests to the unicast content server 110. The proxy 112 makes requests for any other data in the first set of data from the retransmission server 108. As this data has already been multicast, the proxy 112 requests this data before it requests any data in the second set of data. By obtaining content data in such a manner from the retransmission server 108 and the content server 110, the proxy is able to “catch-up” with the multicast (via the data available from the retransmission server 108) whilst ensuring that all the data requested satisfies any session-specific security requirements. In relation to the session-specific security requirements, forwarded requests by the proxy 112 from the client device 114 will naturally have the requisite security parameters as the request originates from the client device 114, and requests to the retransmission server 108 does not have any such security requirements.

The proxy 112 can control the requests for data from the unicast content server 110 and the requests for data from the retransmission server 108 to try to ensure that data is received as fast as possible from the unicast content server 110. The proxy 112 does this so that it can respond to requests from the client device 114 as soon as possible, to avoid the client device 114 from adapting and making subsequent requests for content at a lower level of quality. In particular, the proxy 112 makes requests to the retransmission server 108 in such a way as to avoid the responses from the retransmission server 108 being received at the same time as data is received from the unicast content server 110.

The proxy 112 may choose the amount of data in the first set of data to request from the retransmission server 108, so that the rate at which data can be delivered from the retransmission server 108 is not limited to the rate at which data is delivered on the multicast channel, but can instead be delivered as fast as the network connection to the proxy 112 allows at times during which no data is being received from the unicast content server 110.

The proxy 112 may attempt to minimise the amount of data requested from the retransmission server 108 while still obtaining all of the data needed to “catch up” with the multicast, that is, to have obtained all of the data recently transmitted on the multicast channel. As stated above, this data can be considered in two sets, a first set of data that has already been transmitted on the multicast channel, and a second set of data that will be transmitted on the multicast channel during the time it takes the proxy 112 to obtain the necessary data to “catch-up”. While some or all of the data in the first set could be obtained by waiting for requests from the client device 114 and forwarding these to the unicast server 110, the same cannot be done for the second set, as the timing of the requests from the client device 114 will always be later than the multicast channel, and hence will never enable the proxy to catch-up.

To minimise the time it takes for the proxy 112 to supply the client device 114 with the data it requests, the proxy 112 may choose to make no requests to the retransmission server 108 while data is being received from the unicast server 110 in response to requests from the client device 114 forwarded by the proxy 112, to enable that data to make full use of the network connection to the proxy 112.

The proxy 112 may therefore make its decision of whether to “catch-up” with the multicast channel immediately after delivery of a content segment to the proxy 112 completes (and before any further request for a content segment is received), and at that time may also decide which data to pre-emptively request from the retransmission server 108 first.

To minimise the time taken to “catch-up” with the multicast channel, and minimise the data delivered by the retransmission server 108 to do so, the proxy 112 may try to keep the network connection to the proxy 112 fully utilised at all times. If the proxy 112 determines to start by pre-emptively requesting the newest data from the retransmission server 108, this can only be received as fast as it is being received by the retransmission server 108, which is equal to the rate at which it is transmitted on the multicast channel.

So, to fully utilise the network connection to the proxy 112 in the initial period of pre-emptively requesting data from the retransmission server 108, the proxy 112 may determine to start by pre-emptively requesting data that is towards the end of the first set of data, so that the proxy has “caught-up” with the multicast at the time that the next request from the client device 114 is received, with the data being received at the full network rate. At this time, although the proxy 112 has received the most recent data delivered on the multicast channel, it does not all have the data it needed, as it did not start requesting data at the start of the first set of data.

In this case, the proxy 112 determines the first data to pre-emptively request from the first set of data as follows. The proxy 112 estimates the time until the next request is likely to be received from the client device 114 and determines the amount of data that could be received from the retransmission server 108 in that time. The proxy 112 determines the amount of data that could be received from the second set of data in that same period of time, knowing that this data can only be received at the bit rate of the multicast channel. The proxy 112 then determines the difference between these two quantities of data, and starts to make pre-emptive requests of the retransmission server for data towards the end of the first set of data, where the amount of data requested from the first set of data is equal to the calculated difference. This number of bytes, FirstSetBytes, from the first set of data, is determined as below, where T is the time until the next request is expected to be received from the client device 114, R is the encoded bit rate of the content segments as well as the bit rate of the multicast channel, and B is the bandwidth of the network connection to the proxy 112. Each side of the equation below is an expression for the amount of data that could be received in time T.

$$B \times T = FirstSetBytes + R \times T \qquad ( 1 )$$

This can be re-arranged as below to give an expression for the amount of data, FirstSetBytes, from the first set of data, to pre-emptively request.

$$FirstSetBytes = T ( B - R ) \qquad ( 1 )$$

When the proxy 112 receives a request from the client device 114, it temporarily stops pre-emptively requesting data from the retransmission server 108, forwards the request from the client to the unicast server 110, receives that data and forwards it to the client device 114.

After this temporary interruption to pre-emptively requesting data, the proxy 112 will not have received the most recent data delivered on the multicast channel, and hence resumes making pre-emptive requests for data from the retransmission server 108, until it receives a next request from the client device 114 or “catches-up” with the multicast channel. In the former case, the process above of forwarding the request to the unicast server 110, receiving the data and forwarding to the client device 114 is repeated. In the latter case of “catching-up” with the multicast channel, if all data necessary to transition to multicast has been received, that is, if all the data in the first set of data has been received, the proxy 112 can attempt to join the multicast channel, by, for example, issuing an IGMP JOIN request. If all data the from the first set of data has not been received, either the proxy 112 continues to request data from the retransmission server 108 until a request from the client device is received, or alternatively the proxy 112 may pre-emptively request some or all of the missing data from the first set of data.

The above approach is particularly advantageous when the encoded rate R is more than half the network rate B, as otherwise there are fewer issues joining the multicast immediately and having two streams of data for a while. When R is more than half the network rate B, even though the proxy 112 may have caught up with the multicast when the next request is received from the client device 114, by the time that request has been served, taking more than half the segment period, there is not time for the proxy 112 to catch up with the multicast again. The proxy 112 only finally catches up with the multicast after all requests from the client device 114 that need to be forwarded to the unicast server 110 have been satisfied.

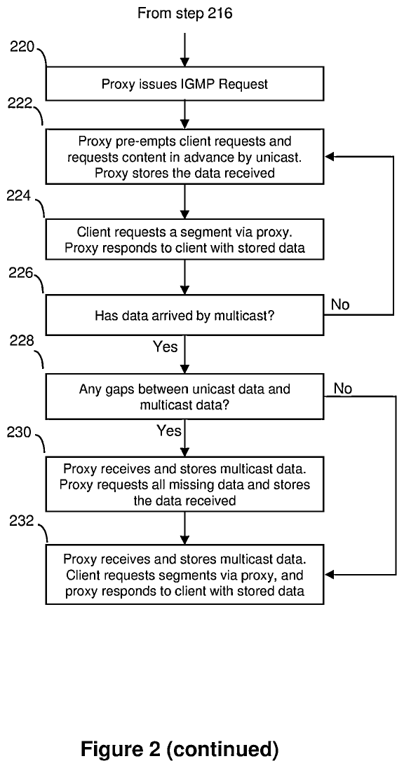

FIG. 2 shows a flow chart summarising the method.

Starting at step 200, the client device 114 makes requests for segments of content stored at the unicast server 110. The proxy 112 intercepts these requests, and forwards the requests to the unicast server 110. The proxy 112 receives the requested segments by unicast from the unicast server 110, and forwards this data to the client device 114 as unicast responses to the requests from the client device 114. The client device 114 receives these segments, which can then be played out.

The client device 114 can request segments using HTTP GET requests, which are unicast in nature, directed to segments of content encoded at a particular bit rate. This initial or first bit rate may be chosen to be the lowest bit rate available, or the bit rate could be chosen in some other way, such as based on historical data or user preference. Each HTTP GET request includes the URL of where that segment can be retrieved from. The URLs are found in the manifest file associated with the content.

In step 202, the proxy 112 decides whether to subscribe to multicast delivery. This decision can be made dependent on many factors including whether the client device 114 has been requesting content that is available by multicast, whether the quality level of segments requested by the client device 114 are being delivered by multicast, whether the client device 114 has been requesting only segments at this quality level for some time, and whether the proxy 112 considers there to be sufficient bandwidth to the client device 114 to maintain timely delivery of segment data at this quality level.

If the proxy 112 decides to subscribe to multicast delivery, flow passes to step 204, otherwise flow passes back to step 200 and the proxy 112 continues to receive and respond as before to unicast requests from the client device 114.

In step 204, the proxy determines the first data to request when making pre-emptive requests for segment data. Methods by which the proxy 112 could perform this determination have been described in detail earlier.

In step 206, the proxy 112 pre-empts unicast requests from the client device 114 and requests content by unicast from the retransmission server 108 before it has been requested by the client device 114. The proxy 112 stores the data received in response to the unicast content requests.

In step 208, the proxy 112 determines whether the client device 114 has made a request for a segment of content stored at the unicast server 110. If so, flow passes to step 210, otherwise flow passes to step 216.

In step 210, the proxy 112 determines whether the segment of content for which the client device 114 has made a request is already fully stored at the proxy 112. For example, the requested segment may be stored as a result of a pre-emptive request in step 206. If so, flow passes to step 214, otherwise flow passes to step 212.

In step 212, the proxy 112 determines how much of the segment of content for which the client device 114 has made a request is already fully stored at the proxy 112. Part of the segment may already be stored at the proxy 112, having been obtained by a pre-emptive request in step 206, or none of the segment may already be stored at the proxy 112. The proxy 112 forwards the request from the client device 114 to the unicast server 110, modified if necessary, to request only the data that is not already stored at the proxy 112. The proxy 112 receives the requested data by unicast from the unicast server 110, and combines this with any part of the requested segment already stored at the proxy 112, and forwards the data for the whole segment to the client device 114 as a unicast response to the request from the client device 114. The client device 114 receives the segment, which can then be played out. Flow passes to step 216.

In step 214, the proxy 112 responds to the client device 114 with a unicast response including data that had already been requested, received, and stored from step 206. The client device 114 receives the segment, which can then be played out. Flow passes to step 216.

In step 216, the proxy 112 determines whether any more data could be pre-emptively requested by unicast. The proxy 112 could, for example, issue a request for more content and in the event of receiving an error response, such as an HTTP error code 404, conclude that no more data is available. This is an indication that the proxy 112 has already obtained most or all of the data recently made available on the multicast channel. If the proxy 112 determines that there is more data available, flow passes back to step 206 where that data is requested. Otherwise flow passes to step 220.

In step 220, the proxy 112 initiates the process of joining the multicast channel. This may be done for example by issuing an IGMP Join request.

In step 222, the proxy 112 again pre-empts unicast requests from the client device 114 and requests content by unicast before it has been requested by the client device 114. Some of these requests may fail because there is no data available as the proxy 112 has already obtained most or all of the data recently delivered over the multicast channel, but some may succeed, in which case the proxy 112 stores the data received in response to the unicast content requests.

In step 224, the client device 224 makes requests for segments of content stored at the unicast server 110. The proxy 222 again intercepts these requests and responds to the client device 114 with unicast responses including data that had been requested, received, and stored on steps 206 or 222. The received segments can then be played-out by the client device 224. Flow passes to step 226.

In step 226, the proxy 112 determines whether it has received any data on the multicast channel that has been subscribed to from step 220. If no data has been received, flow passes to step 222, and the proxy 112 continues to make pre-emptive requests for content. Otherwise flow passes to step 228.

In step 228, the proxy 112 determines whether there is any data missing between the data it has received in steps 200, 206, 212 and 222 and the data that has been received on the multicast channel. If there is no missing data, flow passes to step 232, otherwise flow passes to step 230.

In step 230, the proxy 112 receives data on the multicast channel and stores that data. The proxy 112 pre-empts unicast requests from the client and requests content by unicast before it has been requested by the client device 114. Specifically, the proxy 112 requests the data that has been identified as being missing data in step 228. The proxy 112 stores the data received in response to the unicast content requests. Flow passes to step 232.

In step 232, the proxy 112 receives data on the multicast channel and stores that data. The client device 114 makes requests for segments of content stored at the unicast server 110. The proxy 112 intercepts these requests and responds to the client device 114 with unicast responses including data that had been received and stored in earlier steps. This data may have been received at the proxy 112 by unicast delivery or by multicast delivery on the multicast channel. The segments are received by the client device 114, and can then be played-out.

There now follows two worked examples to further illustrate the main solution.

As described above, the proxy 112 obtains data faster than it is requested by the client device 114 for the purpose of transitioning from receiving content by unicast to receiving content by multicast, while being able to respond to requests for content segments from the client device in a timely manner to prevent the latter from adapting and requesting further content segments at a lower level of quality.

Also as described above, the proxy 112 considers these data as two sets of data: a first set of data that has already been delivered on the multicast channel and a second set of data that has not yet been delivered on the multicast channel.

In the first of the two examples, all data in the first set of data is requested from the unicast content server 110 in response to corresponding requests from the client device 114, and all data in the second set of data is requested pre-emptively from the retransmission server 108, ahead of corresponding requests from the client device 114.

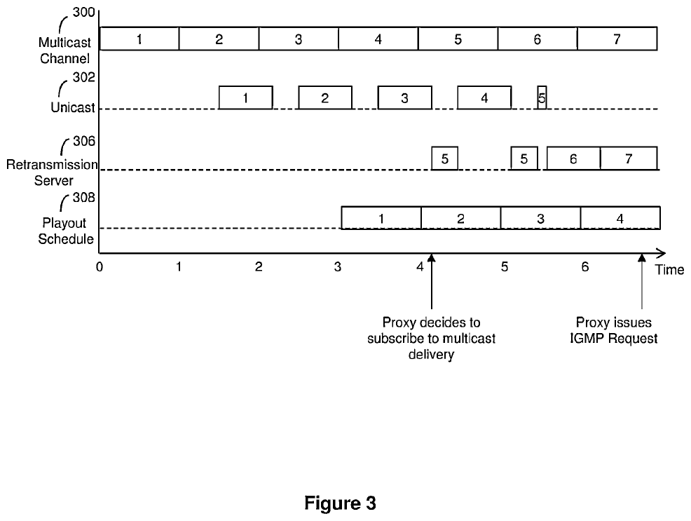

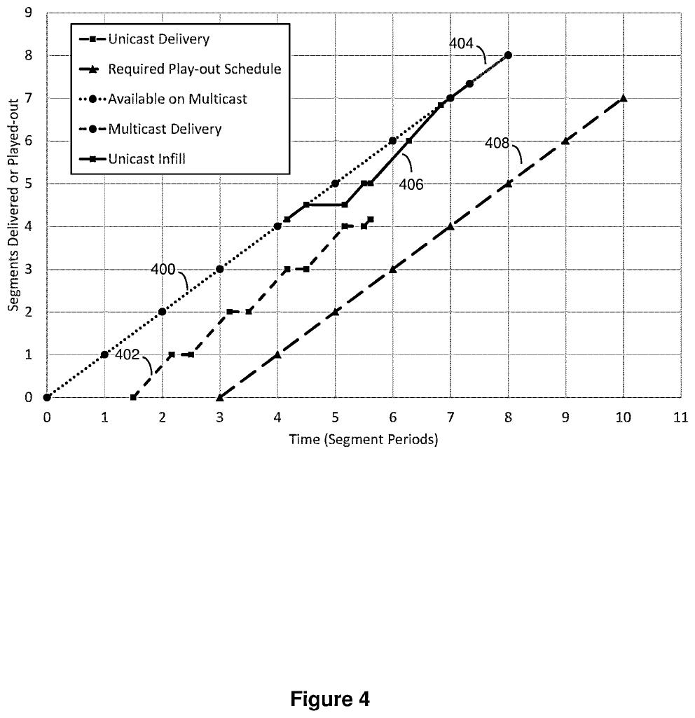

FIG. 3 and FIG. 4 show the timing of the requesting of data by the proxy 112 in this first example.

This is followed by a second example in which some of the data in the first set of data is requested from the unicast content server 110 in response to corresponding requests from the client device 114, and the remaining data in the first set of data and all of the data in the second set of data is requested from the retransmission server 108, ahead of corresponding requests from the client device 114. Appropriate selection of the amount of data in the first set of data to request from the retransmission server 108 enables the total amount of data that is requested from the retransmission server 108 to be reduced by performing the transition to multicast in a shorter period of time.

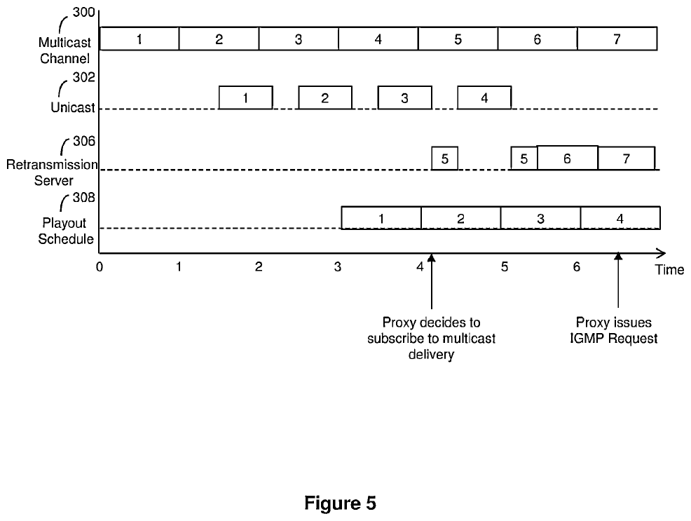

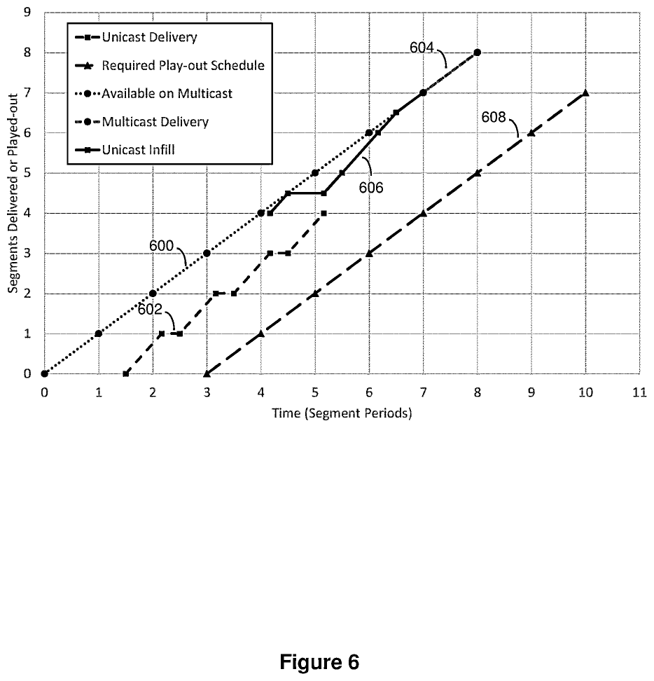

FIG. 5 and FIG. 6 show the timing of the requesting of data by the proxy 112 in this second example.

FIG. 1 shows an example of a system model used in both these examples.

The client device 114 is a standard ABR client that requests content segments periodically at intervals equal to the segment period. Content requests from the client device 114 are intercepted by a proxy 112 that has a high bandwidth connection to the client device 114. The proxy 112 obtains the data requested by the client device 114 either by forwarding the client request and receiving the data by unicast, by pre-emptively requesting the data from a retransmission server 108, or by joining a multicast stream and receiving the data by multicast.

The following assumptions are also made in the examples.

The content is split into segments of fixed duration and encoded at multiple quality levels. Although in reality, client devices may start at a lower level of quality, determine the available network throughput and then progress to a higher quality, in these examples, the client device 114 is assumed to have already reached the state of requesting segments at a stable quality, equal to the quality that is available by multicast. In this illustrative example, the encoded rate for this quality is 10 Mbit/s. The client device 114 is assumed to have a fixed bit rate connection to the content server 110 at a bit rate of 15 Mbit/s, comprised of a high-speed connection to the proxy 112 and a connection at 15 Mbit/s from the proxy 112 to the content server 110.

It should be noted that this 15 Mbit/s bandwidth is insufficient to receive simultaneously the multicast at 10 Mbit/s and a content segment by unicast within a segment period, which would require an additional 10 Mbit/s. If a segment is not delivered within a segment period, content may not be delivered in time and hence play-out may stall. Also, the client device 114, which is unaware of the proxy 112 and its possible use of multicast, may interpret a segment taking more than a segment period to be delivered as a sign of network congestion and switch to requesting a lower quality of content from the ABR hierarchy.

The data of a segment is delivered by multicast as it is being generated by the encoding process. In these examples, multicast delivery is at the encoded bit rate, that is, at 10 Mbit/s. After the segment has been fully delivered by multicast it is made available for unicast delivery. The client device requests a segment a fixed time after the segment is first made available. In these examples, the client requests each content segment 1.5 segment periods after the transmission of the segment starts on the multicast, which is equal to 0.5 segment periods after the transmission of the segment ends on the multicast. The client device starts to play-out the first segment 1.5 segment periods after requesting it, that is, 3.0 segment periods after the segment started to be transmitted by multicast.

In these examples, the proxy 112 determines to use multicast delivery after delivery of segment 3 by unicast has finished.

The units of time used in the examples is the segment period, which may be 2 s, 6 s, 10 s, or any other value.

Turning now to the first example with reference to the timing diagrams in FIG. 3 and FIG. 4. In FIG. 3 (and FIG. 5), the time shown is in relation to transmission of segment data over the multicast channel 300, transmission from the unicast server 302, and transmission from the retransmission server 306.

The example starts at time zero, when transmission of segment 1 by multicast starts over the multicast channel by the multicast transmitter 106. Multicast is not received by the example client device 114 at this point, but may be received by other client devices from this point. At time 1, transmission of segment 1 by multicast finishes, and transmission of segment 2 starts, and so on. This is shown in the first row labelled “Multicast Channel” 300 in FIG. 3 and by the dotted line 400 with circular data points in FIG. 4.

The client device 114 makes a request for segment 1 at time 1.5 by unicast. As the segment is encoded at 10 Mbit/s, and the fixed bit rate available from the content server 110 to the client device 114 is 15 Mbit/s, it takes 10/15=0.67 segment periods for the content to be delivered to the client device 114, and hence is delivered by time 1.50+0.67=2.17. This is shown as the second row labelled “Unicast” 302 in FIG. 3 and by the dashed line 402 with square data points in FIG. 4.

As is typical in ABR streaming in the steady state, the client device 114 does not make a request for the next segment immediately, but waits until one segment period after the previous request before making the next request. The client device 114 therefore requests segment 2 at time 2.5 by unicast. Similar to segment 1, this takes 0.67 to be delivered and is delivered by time 2.50+0.67=3.17. The client device 114 again waits, this time until time 3.5, at which it requests segment 3, which again arrives 0.67 later at time 3.50+0.67=4.17. At this time, as shown in FIG. 3, the proxy 112 determines to use multicast delivery, but does not at this time attempt to join the multicast channel. The client device 114 is unaware of this and will continue to request segments by unicast.

In this example, at this time, transmission of segment 5 has just started on the multicast channel. The proxy 112, while awaiting the request from the client device 114 for the next segment, which is segment 4, makes requests to the retransmission server 108 for data recently transmitted on the multicast channel. This is an early part of segment 5, but not the start of segment 5. This data is delivered as fast as it becomes available, that is, at the multicast rate, and hence at this time, the full network capacity to the proxy 112 is not used. Data that is requested from the retransmission server 108, including this early part of segment 5, is shown in the third row labelled as “Retransmission Server” 306 in FIG. 3 and by the solid line 406 with square data points in FIG. 4.

The client device 114 requests segment 4 at time 4.5, unaware of the proxy 112 and its request for data from the retransmission server 108. When the proxy 112 receives the request for segment 4 from the client device 114, the proxy stops requesting data from the retransmission server 108, and forwards the request from the client device 114 to the unicast server 110. By stopping requesting data from the retransmission server, all of the network capacity to the proxy 108 can be used for delivery of the segment from the unicast server 110, allowing that delivery to take place as fast as possible.

Similar to the delivery of earlier segments from the unicast server 110, it takes 0.67 to receive segment 4, which completes delivery at time 4.50+0.67=5.17. At this time the proxy 112 resumes requesting parts of segment 5 from the retransmission server 108, and continues to do so until it receives a request for segment 5 from the client device at time 5.5. At this time the proxy 112 stops requesting data from the retransmission server 108, and forwards the request for segment 5 to the unicast server in such a way that only the missing, initial, part of segment 5 is delivered from the unicast server 110.

When the delivery of the remaining part of segment 5 has finished, the proxy requests data from segment 6, and then segment 7 from the retransmission server 108 until such time that it has all of the data that has been delivered on the multicast channel, that is, it has “caught-up” with the multicast channel. The proxy 112 then issues a command to join the multicast stream, and after a period of time, equal to 0.5 segment periods in these examples, multicast data starts to be received at the proxy 112. During this period the proxy may choose to continue to request data from the retransmission server 108 as it becomes available.

In this example, all of the data requested by the proxy 112 from the unicast server 110 by forwarding requests from the client device 114, and all of the data requested by the proxy 112 from the retransmission server 108 pre-empting requests from the client device 114, is delivered at the highest possible speed of 15 Mbit/s, except for the first data requested from the retransmission server 108, being the early part of segment 5, which can only be delivered as fast as it becomes available, that is, at the multicast rate.

If all of the data were requested from the retransmission server 108 in the period between deciding to subscribe to multicast delivery and “catching-up” with the multicast, and if that data were delivered at the highest possible speed of 15 Mbit/s, 3.50 segments of data would be requested from the retransmission server 108 in the period from time 4.17 to time 6.50. But in the example above, with some data being requested from the unicast server 110, only 2.67 segments of data would be requested from the retransmission server 108 in the period from time 4.17 to time 6.83, a reduction of 23.8% in the amount of data requested from the retransmission server 108.

However, it is possible to reduce the amount of data requested from the retransmission server 108 even further, by ensuring that all such data could be delivered at the full rate of the connection to the proxy 112.

Turning now to the second example, with reference to the timing diagrams in FIG. 5 and FIG. 6.

The behaviour of the client device 114 and the timing of the receipt of data is the same as in the first example described above until time 4.17 when all of the data for segment 3 has been received by unicast and the proxy 112 determines multicast delivery should be used.

In the first example, the proxy 112, while awaiting the request from the client device 114 for the next segment, which is segment 4, makes requests to the retransmission server 108 for data recently transmitted on the multicast channel. This is an early part of segment 5, but not the start of segment 5. But as this is the most recent data on the multicast channel, it can only be received from the retransmission server 108 as fast as it is being delivered on the multicast channel, which in this example is at 10 Mbit/s. This means that some of the network connection to the proxy, which has capacity of 15 Mbit/s, cannot be used at this time.

Hence in this second example, the proxy 112 does not make requests to the retransmission server 108 for the most recently transmitted data on the multicast channel, but starts by requesting data that was transmitted on the multicast channel slightly earlier, so that this data can be delivered at the speed of network connection to the proxy, 15 Mbit/s. The proxy predicts when the next request will be made by the client device 114, and determines the first data to request from the retransmission server 108 such that all subsequent data delivered on the multicast channel until the time the next request is received from the client device 114, is received at the speed of network connection to the proxy, 15 Mbit/s. By doing so, the proxy can maximise the use of the network connection to the proxy 112, and ensure that it will ultimately “catch-up” with the multicast as soon as possible, and require the minimum amount of data from the retransmission server 108 to do so.

An example of the calculation that the proxy 112 could perform to determine the initial data to request from the retransmission server 108 is shown below in equation (3), where t is the current time, T is the time the proxy predicts the client device will request the next segment (in this example, segment 4), B is the speed of the network connection to the proxy, and M (T) is the amount of data that would have been transmitted on the multicast channel by time T.

$$InitialData = M ( T ) - B ( T - t ) \qquad ( 2 )$$

In this example, t=4.17, T=4.50, B=1.50 (in units of segments per segment period), and M (T) is 4.50 segments, resulting in a determined value of 4.50−1.50×(4.50−4.17)=4.00 for the initial data to request, and hence in this case the proxy would start by requesting the beginning of segment 5 from the transmission server.

The behaviour is then the same as in the first example, but with the proxy 112 starting by requesting the start of segment 5 from the retransmission server 108, and later with the proxy 112 pausing requesting data from the retransmission server 108 when it receives the request for segment 4 from the client device 114, and continuing as in the first example until “catching-up” with the multicast, which in this case happens at time 6.50 rather than time 6.83 in the first example. Unlike the first example, when the proxy 112 receives the request from the client device 114 for segment 5, it does not need to forward this to the unicast server 110 as all of segment 5 has already been received.

In this example, during the period between deciding to subscribe to multicast delivery and “catching-up” with the multicast, 1.00 segments were requested from the unicast server 110, being the whole of segment 4, and 2.50 segments of data were requested from the retransmission server 108, a reduction of 28.6% in the amount of data requested from the retransmission server 108 compared to a reduction of 23.8% in the first example.

In summary, it is clear from the above examples, and from the timing diagrams of FIGS. 3 and 5, that once the proxy decides to subscribe to multicast delivery, content segments are requested and received over unicast from the content server 110 and the retransmission server 108, until the received content segments “catch-up” with that available over multicast. Only when the received unicast content segments have caught-up with the multicast does the proxy 112 issue a request to join the multicast channel.

In general, it is noted herein that while the above describes examples of the invention, there are several variations and modifications which may be made to the described examples without departing from the scope of the present invention as defined in the appended claims. One skilled in the art will recognise modifications to the described examples.

1. A method of managing content delivery to a client device by a network element, said content comprising a sequence of segments, said method comprising:
receiving requests for segments from a client device, and transmitting the requested segments to the client device by unicast, wherein the transmitted segments are obtained by the network element by:
i) requesting one or more of the requested segments from a unicast content source;
ii) deciding to join a multicast channel; then
iii) requesting and receiving further segments from the unicast content source and an alternative unicast content source, and storing the further segments until requested by the client device; and
iv) joining a multicast channel and receiving segments over multicast, and storing the segments until requested by the client device.

2. A method according to claim 1, wherein the further content segments from the unicast content source are requested in response to corresponding requests received from the client device.

3. A method according to claim 1, wherein the further content segments from the alternative unicast content source are requested in advance of corresponding requests from the client device.

4. A method according to claim 1, wherein at any given time, there is segment data available by multicast and from the alternative unicast source that isn't yet available from the unicast content source.

5. A method according to claim 1, wherein the alternative unicast content source is a retransmission server.

6. A network element for managing content delivery to a client device, said content comprising a sequence of segments, said network element adapted in operation to:
receive requests for segments from a client device, and transmit the requested segments to the client device by unicast;
request one or more of the requested segments from a unicast content source;
decide to join a multicast channel;
request and receive further segments from the unicast content source and an alternative unicast content source, and storing the further segments until requested by the client device; and
join a multicast channel and receiving segments over multicast, and storing the segments until requested by the client device.
